(19) United States
(12) Patent Application Publication
(10) Pub. No.: US 2013/0312706 A1
(43) Pub. Date: Nov. 28, 2013

(54) FUEL SYSTEM HAVING FLOW-DISRUPTION REDUCER

(71) Applicants: Christopher J. SALVADOR, Peoria, IL (US); Patrick W. Savage, JR., Washington, IL (US); Mark T. Allott, Mapleton, IL (US); Jeffrey R. Ries, Metamora, IL (US); Ken C. Adams, Dunlap, IL (US)

(72) Inventors: Christopher J. SALVADOR, Peoria, IL (US); Patrick W. Savage, JR., Washington, IL (US); Mark T. Allott, Mapleton, IL (US); Jeffrey R. Ries, Metamora, IL (US); Ken C. Adams, Dunlap, IL (US)

(21) Appl. No.: 13/478,751

(22) Filed: May 23, 2012

(51) Int. Cl. F02M 69/54; F16K 21/00; F02M 37/22

(52) U.S. Cl. 123/457; 137/544; 137/511

(57) ABSTRACT

A fuel system for an engine is disclosed. The fuel system may have a filter, a pump, and a conduit fluidly connected between the filter and the pump. The fuel system may also have a manifold, and a valve movable to direct a first portion of a fuel flow discharged from the pump into the manifold and a remaining second portion of the fuel flow discharged from the pump into the conduit. The fuel system may additionally have a flow-disruption reducer disposed within the conduit between the filter and a discharge location of the remaining second portion of the fuel flow.

### TECHNICAL FIELD

The present disclosure is directed to a fuel system and, more particularly, to a fuel system having a flow-disruption reducer.

### BACKGROUND

Common rail fuel systems provide a way to simultaneously introduce high-pressure fuel from a common high-pressure supply into parallel combustion chambers of an engine. Typical common rail fuel systems include a low-pressure transfer pump that draws fuel from a tank and supplies the fuel through one or more filters to a high-pressure pump. The high-pressure pump increases a pressure of the fuel up to, for example, about 100-300 MPa, before directing the high-pressure fuel to a common rail or manifold. The common rail then distributes the fuel to individual injectors within the engine.

One type of high-pressure pump utilized to provide fuel to the common rail is known as a fixed-displacement, variable-delivery pump. This type of pump generally includes one or more plungers that are disposed within corresponding barrels and operatively driven by rotating cams. As the cams rotate, fuel is drawn into each barrel and then subsequently forced from the barrel at high-pressure by an associated plunger. The amount of fuel discharged from each barrel remains about the same for each rotation of the cam.

Because engine demand for fuel varies during operation, the amount of fuel delivered to the injectors of the engine should also vary to match demand. In the fixed-displacement type of pump described above, delivery may be varied through the use of a spill valve. In particular, the spill valve selectively directs a desired portion of the fuel discharged from the barrels of the pump to the common rail for distribution to the injectors; and a remaining portion is “spilled” back to a suction side of the pump. In this manner, although displacement of the pump is fixed, delivery of fuel from the pump to the common rail is variable.

One problem associated with a common rail fuel system that is equipped with a fixed-displacement, variable-delivery pump involves pressure oscillations caused by the spilling of high-pressure fuel to the suction side of the pump. In particular, this high-pressure fuel, as it is spilled to a location upstream of the pump (i.e., between the filters and the pump where the fuel pressure is normally relatively low), can create a pressure spike that travels upstream through the filters of the fuel system. This pressure spike can result in a flow-reversal of the fuel within the filters, which may cause damage to the filters. In some systems, the flow of fuel through the filters, particularly the filter located closest to the pump, can occur dozens of times per second.

The fuel system of the present disclosure addresses one or more of the problems set forth above and/or other problems of the prior art.

### SUMMARY

One aspect of the present disclosure is directed to a fuel system. The fuel system may include a filter, a pump, and a conduit fluidly connected between the filter and the pump. The fuel system may also include a manifold, and a valve movable to direct a first portion of a fuel flow discharged from the pump into the manifold and a remaining second portion of the fuel flow discharged from the pump into the conduit. The fuel system may additionally have a flow-disruption reducer disposed within the conduit between the filter and a discharge location of the remaining second portion of the fuel flow.

Another aspect of the present disclosure is directed to method of supplying fuel to an engine. The method may include directing fuel through a filter to a pump, and increasing a pressure of the fuel within the pump. The method may also include directing a first portion of the pressurized fuel to a manifold for injection into the engine, and directing a remaining second portion of the pressurized fuel to a low-pressure side of the pump. The method may additionally include reducing at least one of a flow rate and a pressure of the remaining second portion of the pressurized fuel directed to the filter.

Another aspect of the present disclosure is directed to a flow-disruption reducer. The flow disruption reducer may include a housing having an inlet and an outlet, and a valve element disposed within the housing. The valve element may be movable from a first position at which fluid flow from the inlet to the outlet is blocked, to a second position at which fluid flow from the inlet to the outlet is allowed. The valve element may be moved from the first position to the second position when a pressure of fluid at the inlet is greater than a pressure of fluid at the outlet. The valve element has a mass-to-area ratio such that the valve element remains away from the first position when exposed to a pulse of fluid at the outlet having a pressure higher than a pressure of fluid at the inlet and a frequency of about 30-35 Hz.

### BRIEF DESCRIPTION OF THE DRAWING

FIG. 1 is a partial cross-sectional and diagrammatic illustration of an engine equipped with an exemplary disclosed fuel system.

### DETAILED DESCRIPTION

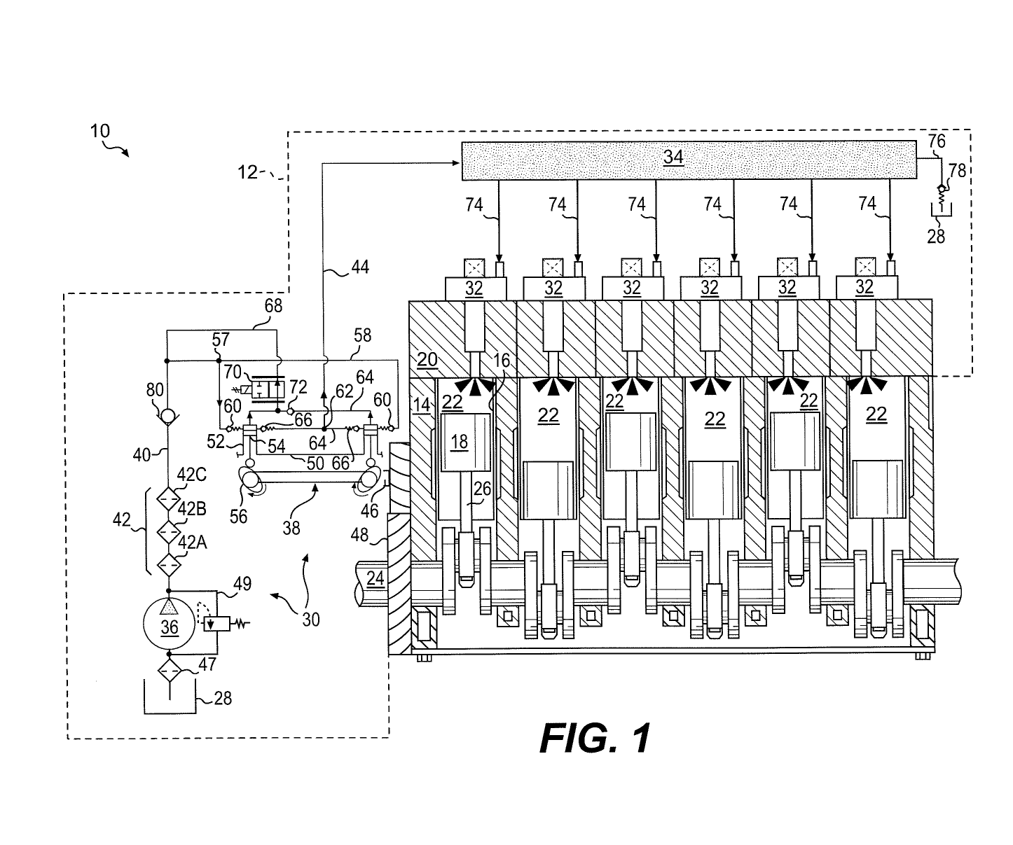

FIG. 1 illustrates an engine 10 equipped with an exemplary embodiment of a fuel system 12. For the purposes of this disclosure, engine 10 is depicted and described as a four-stroke diesel engine. One skilled in the art will recognize, however, that engine 10 may be any other type of internal combustion engine such as, for example, a gasoline engine. Engine 10 may include an engine block 14 that at least partially defines a plurality of cylinders 16, a piston 18 slidably disposed within each cylinder 16, and a cylinder head 20 associated with each cylinder 16.

Cylinder 16, piston 18, and cylinder head 20 together may form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, in a “V” configuration, in an opposing-piston configuration, or in another suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into combustion chambers 22 during each rotation of crankshaft 24. Specifically, fuel system 12 may include a tank 28 configured to hold a supply of fuel, and a fuel pumping arrangement 30 configured to pressurize the fuel and direct the pressurized fuel to a plurality of fuel injectors 32 by way of a common rail or manifold 34.

Fuel pumping arrangement 30 may include one or more pumping devices that function to increase the pressure of the fuel drawn from tank 28, and direct one or more pressurized streams of fuel to common rail 34. In one example, fuel pumping arrangement 30 includes a low-pressure pump 36 and a high-pressure pump 38 disposed in series and fluidly connected to each other by way of a conduit 40. Low-pressure pump 36 may be a transfer pump configured to draw low-pressure fuel from tank 28 and provide the low-pressure fuel (e.g., fuel having a pressure of about 0.1-1.5 MPa) to high-pressure pump 38 via one or more filters 42. High-pressure pump 38 may be configured to receive the low-pressure fuel and increase the pressure of the fuel into the range of about 100-300 MPa. High-pressure pump 38 may be connected to common rail 34 by way of a fuel line 44.

One or both of low- and high-pressure pumps 36, 38 may be operably connected to engine 10 and driven by crankshaft 24. Low- and/or high-pressure pumps 36, 38 may be connected with crankshaft 24 in any manner readily apparent to one skilled in the art, where a rotation of crankshaft 24 will result in a corresponding rotation of a pump drive shaft. For example, a pump driveshaft 46 of high-pressure pump 38 is shown in FIG. 1 as being connected to crankshaft 24 through a gear train 48. It is contemplated, however, that one or both of low and high-pressure pumps 36, 38 may alternatively be driven electrically, hydraulically, pneumatically, or in any other appropriate manner.

In the disclosed embodiment, filters 42 include a primary filter 42A, a secondary filter 42B, and a tertiary filter 42C that are fluidly connected within conduit 40 in series relation. It should be noted that any number of filters 42 may be disposed in this location. Filters 42 may be configured to remove debris and/or water from the fuel pressurized by low-pressure pump 36. Filters 42 may be substantially identical to each other, and have a rated filtration of, for example, about 4 μm. In some embodiments, an additional filter 47 having a lower efficiency rating may also be utilized and located upstream of low-pressure pump 36, if desired. For example, filter 47 may be located between low-pressure pump 36 and tank 28, and have a rated filtration of about 10 μm. Thus, filter 47, if present, may remove less material from a given fuel flow than any of filters 42. It is contemplated that filter 47 may additionally function as a fuel/water separator, if desired.

A pressure relief circuit 49 may be disposed in parallel with low-pressure pump 36 to allow fuel having a pressure greater than a predetermined pressure to return to the inlet of low-pressure pump 36. In this manner, components of engine 10 may be protected from excessive pressure spikes. In addition, by returning this fuel to the intake of low-pressure pump 36, rather than to tank 28, less fuel may flow through filter 47 located between tank 28 and low-pressure pump 36. The reduced flow of fuel through filter 47 may help to prolong the component life of filter 47.

In the disclosed embodiment, high-pressure pump 38 may be a fixed-displacement pump. Accordingly, high-pressure pump 38 may include a housing 50 at least partially defining one or more barrels 52, and a plunger 54 slidably disposed within each barrel 52. In this arrangement, each pairing of plunger 54 and barrel 52 may form a pumping chamber. A driver 56 may operatively connect the rotation of driveshaft 46 to plunger(s) 54 and include any means for driving plunger 54 in a reciprocating manner within barrel(s) 52 (e.g., a cam having any number of cam lobes). During each rotation of driver 56, each plunger 54 present within high-pressure pump 38 may discharge a fixed amount of fuel at a particular pressure.

An inlet 57 may fluidly connect conduit 40 with the pumping chamber(s) of high-pressure pump 38 via a low-pressure gallery 58. One or more check valves 60 may be disposed between low-pressure gallery 58 and the pumping chamber(s) to provide for a unidirectional flow of low-pressure fuel into the pumping chamber(s).

An outlet 62 may fluidly connect the pumping chamber(s) of high-pressure pump 38 with passage 42 via a high-pressure gallery 64. One or more check valves 66 may be disposed between the pumping chamber(s) and high-pressure gallery 64 to provide for a unidirectional flow of pressurized fuel into high-pressure gallery 64.

High-pressure pump 38 may also be a variable-delivery pump. Specifically, a spill passage 68 may fluidly connect the pumping chamber(s) with conduit 40, and a spill valve 70 may be disposed within spill passage 68. Spill valve 70 may be movable between a flow-passing position and a flow-blocking position to selectively allow some of the fuel displaced from the pumping chamber(s) to flow through spill passage 68 back into conduit 40. The amount of fuel displaced (i.e., spilled) from the pumping chamber(s) into conduit 40 may be inversely proportional to the amount of fuel displaced (i.e., pumped) into high-pressure gallery 64.

In some embodiments having multiple pumping chambers, the fluid connection between the pumping chambers and spill valve 70 may be established by way of a selector valve 72. Selector valve 72 may function to allow only one of the pumping chambers to spill fuel into conduit 40 at a time. Because plungers 54 of different pumping chambers may move out of phase relative to one another, one pumping chamber may be at high-pressure (pumping stroke) when another pumping chamber is at low-pressure (intake stroke), and vice versa. This action may be exploited to move an element of selector valve 72 back and forth to fluidly connect either pumping chamber with spill valve 70. Thus, the pumping chambers may share a common spill valve 70 in the disclosed embodiment. It is contemplated, however, that a separate spill valve 70 may alternatively be dedicated to controlling the effective displacement of fuel from each individual pumping chamber, if desired.

Spill valve 70 may be normally biased toward a first position, at which high-pressure fuel is allowed to flow into conduit 40. Spill valve 70 may also be moved by way of a solenoid (i.e., spill valve 70 may be an electronically controlled valve) or pilot force (i.e., spill valve 70 may be a pilot operated valve) to a second position, at which high-pressure fuel is blocked from flowing into conduit 40. The movement timing of spill valve 70 between the flow passing and flow blocking positions, relative to the displacement position of plunger(s) 54, may determine what fraction of the fuel displaced from the pumping chamber(s) spills to conduit 40 or is pumped through high-pressure gallery 64 to common rail 34.

Fuel injectors 32 may be disposed within cylinder heads 20 and connected to common rail 34 by way of a plurality of individual fuel lines 74, while common rail 34 may be connected to tank 28 by way of a return line 76. A check valve 78, for example a spring-biased check valve, may be disposed within return line 76 to help regulate a pressure of common rail 34. Each fuel injector 32 may be operable to inject an amount of pressurized fuel into an associated combustion chamber 22 at predetermined timings, fuel pressures, and fuel flow rates. The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection that creates a reducing atmosphere for aftertreatment regeneration.

Due to the periodic spilling of high-pressure fuel into conduit 40 at a relatively low-pressure location, pressure waves may be generated that propagate in reverse direction back towards filters 42. In some applications, the spilling of high-pressure fuel may occur at a frequency of about 30-35 Hz. If left unchecked, these pressure waves could result in a disruption of the normal flow of fuel from filters 42 to high-pressure pump 38 (i.e., oscillating fuel flows within filters 42) that damage filters 42 (particularly downstream filter 42C). For this reason, a flow-disruption reducer 80 may be disposed within conduit 40, between filter 42C and the discharge location of spill passage 68.

Flow-disruption reducer 80 may be any device that inhibits or otherwise dampens reverse flow and corresponding pressure spikes within conduit 40. In one embodiment, flow-disruption reducer 80 may be a valve, for example a reed valve or a check valve. A reed valve may include a reed element that is normally closed against an associated orifice. When exposed to fuel flow in one direction (e.g., from filters 42 toward high-pressure pump 38), the reed element may be pushed away from the orifice by a pressure of the fuel flow, thereby opening the orifice and allowing the flow of fuel to pass through the reed valve in a substantially unrestricted manner. When, however, a pressure of fuel at a downstream side of the reed element (e.g., at the high-pressure pump side) exceeds a pressure of the fuel at the upstream side of the reed element (e.g., at the filter side), the reed element may be forced against the orifice, thereby restricting, if not completely blocking, the reverse fuel flow. A reed valve may generally be highly-responsive due to a mass vs. area ratio of the reed element. In the disclosed embodiment, the reed valve may have a responsiveness that matches or exceeds the frequency of pressure spikes caused by spilling pressurized fuel into conduit 40.

A check valve generally includes a ball or cup-like element that shuttles within a bore of a housing between first and second positions. When in the first position, the element may allow fuel flow from filters 42 through an inlet of the valve housing toward high-pressure pump 38 in a substantially unrestricted manner. However, when in the second position, the element may block fuel flow. The element of the check valve may be movable between the first and second positions based on a pressure differential across the element. For example, when a pressure of the fuel at filters 42 is greater than a pressure of fuel at an outlet of the valve housing (i.e., at inlet 57 of high-pressure pump 38), the element may be urged toward the first position. And when the pressure of fuel at the discharge outlet of spill passage 68 is greater than the pressure of fuel at filters 42, the check valve element may be urged toward the second position.

It has been determined that within fuel system 12, the disclosed check valve element may function just as well within conduit 40 as a reed valve, but for a different reason. In particular, the disclosed check valve element may have a mass that causes the element to remain relatively stationary in the first position throughout operation regardless of the pressure spikes experienced during reverse flow situations. That is, as the flow of fuel within conduit 40 reverses back towards filters 42, the fuel may impinge against the heavy check valve element, urging the check valve element toward the second or flow-blocking position. However, because the reverse flow may have such a short duration and the check valve element may have such a large mass vs. area ratio, the check valve element may not actually move substantially before the flow again reverses to the normal direction (i.e., from filters 42 toward high-pressure pump 38). And even though the check valve element may not move to the second position and completely block fuel flow towards filters 42, the impingement of the reverse fuel flow against the heavy check valve element may result in a fuel restricting, flow redirecting and slowing, or otherwise dampening of the reverse flow of fuel to a non-damaging level.

In addition to or in place of a valve, flow-disruption reducer 80 may include a baffle or other device that restricts or dampens fuel flow in only one direction. The baffle could embody, for example, one or more vanes having a leading edge engaged with outer walls of conduit 40 and a trailing edge that terminates inward from the leading edge. In this configuration, the baffles may function to hinder reverse fuel flow (i.e., fuel flow from high-pressure pump 38 towards filters 42), without significantly affecting normal fuel flow (i.e., fuel flow from filters 42 toward high-pressure pump 38). It is contemplated that other similar devices could also be included within flow-disruption reducer 80, if desired.

### INDUSTRIAL APPLICABILITY

The fuel system of the present disclosure has wide application in a variety of engine types including, for example, diesel engines and gasoline engines. The disclosed fuel system may be used in conjunction with any engine where consistent performance and component longevity is important. Fuel system 12 may provide consistent performance by helping to reduce pressure oscillations with fuel flows passing through system 12. Fuel system 12 may improve component longevity by reducing the duration, magnitude, and/or frequency of fuel flow reversals within the components, for example with filters 42.

It will be apparent to those skilled in the art that various modifications and variations can be made to the fuel system of the present disclosure without departing from the scope of the disclosure. Other embodiments will be apparent to those skilled in the art from consideration of the specification and practice of the fuel system disclosed herein. For example, although the disclosed fuel system is described as being a common rail fuel system, it is contemplated that flow-disruption reducer 80 may also be used with similar success in other types of fuel systems. It is intended that the specification and examples be considered as exemplary only, with a true scope of the disclosure being indicated by the following claims and their equivalents.

What is claimed is:

1. A fuel system, comprising:
a filter;
a pump;
a conduit fluidly connected between the filter and the pump;
a manifold;
a valve movable to direct a first portion of a fuel flow discharged from the pump into the manifold and a remaining second portion of the fuel flow discharged from the pump into the conduit; and
a flow-disruption reducer disposed within the conduit between the filter and a discharge location of the remaining second portion of the fuel flow.

2. The fuel system of claim 1, wherein the flow-disruption reducer is configured to inhibit reverse fuel flow to the filter.

3. The fuel system of claim 2, wherein the flow-disruption reducer is configured to inhibit fuel flow only in a direction from the pump toward the filter.

4. The fuel system of claim 1, wherein the flow-disruption reducer is configured to dampen reverse traveling pressure oscillation.

5. The fuel system of claim 1, wherein the flow-disruption reducer is operable at a frequency of about 30-35 Hz.

6. The fuel system of claim 1, wherein:
the flow-disruption reducer is a valve having an element movable between an open position and a closed position;
the element is disposed within a flow path of the remaining second portion of the fuel flow;
the element is urged toward the closed position by the remaining second portion of the fuel flow; and
the element has a mass sufficient to maintain the element away from the closed position when exposed to the remaining second portion of the fuel flow at a frequency of about 30-35 Hz.

7. The fuel system of claim 1, wherein the flow-disruption reducer is a check valve.

8. The fuel system of claim 1, wherein the flow-disruption reducer is a reed valve.

9. The fuel system of claim 1, wherein the flow-disruption reducer is a baffle.

10. The fuel system of claim 1, wherein:
the pump is high-pressure pump; and
the fuel system further includes:
a tank; and
a low-pressure pump disposed between the tank and the filter.

11. The fuel system of claim 10, wherein:
the filter is a first filter; and
the fuel system further includes a second filter disposed between the low-pressure pump and the first filter.

12. The fuel system of claim 11, further including a third filter located between the tank and the low-pressure pump.

13. The fuel system of claim 12, further including a plurality of injectors connected to draw fuel from the manifold in parallel.

14. The fuel system of claim 1, wherein the valve is an electronically controlled spill valve.

15. A method of supplying fuel to an engine:
directing fuel through a filter to a pump;
increasing a pressure of the fuel within the pump;
directing a first portion of the pressurized fuel to a manifold for injection into the engine;
directing a remaining second portion of the pressurized fuel to a low-pressure side of the pump; and
reducing at least one of a flow rate and a pressure of the remaining second portion of the pressurized fuel directed to the filter.

16. The method of claim 15, wherein reducing the flow of the remaining second portion of the pressurized fuel includes inhibiting fuel flow only from the pump to the filter.

17. The method of claim 15, wherein reducing the flow of the remaining second portion of the pressurized fuel includes dampening pressure oscillations in fuel flow between the pump and the filter.

18. The method of claim 15, wherein:
the pump is a high-pressure pump;
the filter is a first filter; and
the method further includes:
drawing fuel from a tank through a second filter with a low-pressure pump;
directing fuel from the low-pressure pump through a third filter and the first filter in series; and
directing pressurized fuel from the manifold to a plurality of fuel injectors in parallel.

19. The method of claim 18, wherein the first portion is variable based on a demand for fuel from the engine.

20. An engine, comprising:
an engine block at least partially defining a plurality of combustion chambers;
a plurality of fuel injectors associated with the plurality of combustion chambers;
a manifold fluidly connected to each of the plurality of fuel injectors in parallel;
a high-pressure pump fluidly connected to the manifold;
a plurality of filters disposed in series;
a conduit fluidly connected between the plurality of filters and the high-pressure pump;
a tank;
a low-pressure pump fluidly connected between the tank and the plurality of filters.
a first valve movable to direct a variable first portion of a fuel flow discharged from the high-pressure pump into the manifold and a remaining second portion of the fuel flow discharged from the high-pressure pump into the conduit; and
a second valve disposed within the conduit between a downstream one of the plurality of filters and a discharge location of the remaining second portion of the fuel flow, the second valve configured to reduce at least one of a flow rate and a pressure of the remaining second portion of the fuel flow directed through a downstream one of the plurality of filters.

21. A flow-disruption reducer, comprising:
a housing having an inlet and an outlet; and
a valve element disposed within the housing and being movable from a first position at which fluid flow from the inlet to the outlet is blocked, to a second position at which fluid flow from the inlet to the outlet is allowed, the valve element being moved from the first position to the second position when a pressure of fluid at the inlet is greater than a pressure of fluid at the outlet,
wherein the valve element has a mass-to-area ratio such that the valve element remains away from the first position when exposed to a pulse of fluid at the outlet having a pressure higher than a pressure of fluid at the inlet and a frequency of about 30-35 Hz.

22. The flow reducer of claim 21, wherein the pressure at the inlet is about 0.1-1.5 MPa.

23. The flow reducer of claim 22, wherein the pulse of fluid at the outlet has a pressure of about 100-300 MPa.
